(19) United States
(12) Patent Application Publication
(10) Pub. No.: US 2005/0114400 A1
(43) Pub. Date: May 26, 2005

(54) Questionnaire network for mobile handsets

(76) Inventor: Bindu Rama Rao, Laguna Niguel, CA (US)

Correspondence Address: Bindu Rama Rao, 21 Henley Drive, Laguna Niguel, CA, 92677, US

(21) Appl. No.: 10/985,702

(22) Filed: Nov. 10, 2004

Related U.S. Application Data
(60) Provisional application No. 60/524,568, filed on Nov. 24, 2003.

(51) Int. Cl. G06F 17/00

(52) U.S. Cl. 707/104.1

(57) ABSTRACT

In general, a questionnaire network makes it possible to create, disseminate, conduct questionnaires or surveys on mobile handsets and to collect results for processing and storage. In one embodiment, supplementary information, in audio form, is provided to the user to provide more details about a question when the user requests it. In addition, audio preambles for the questionnaire and for individual questions are possible that make it easy to setup the context for the questionnaire or an individual question without requiring the user to read a lot of textual information in a constrained device.

### RELATED APPLICATIONS

This patent application makes reference to, claims priority to and claims benefit from U.S. Provisional Patent Application Ser. No. 60/524,568, entitled “QUESTIONNAIRE NETWORK FOR MOBILE HANDSETS,” filed on Nov. 24, 2004, docket number BRR2003US03. The complete subject matter of the above-referenced United States Provisional Patent Application is hereby incorporated herein by reference, in its entirety.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Electronic devices, such as mobile phones and personal digital assistants (PDA's), often contain small screens with very limited viewing area. They are constrained in terms of how much information can be displayed, and in terms of user interaction capabilities. The keyboards on cell phones, for example, are not conducive for user data entry, and only brief user inputs can be solicited from a user without annoying the user.

User interaction in real time, such as those provided for a user using a PC on the Internet, are often not possible for a user using a cell phone. For example, the amount of textual information cannot be a full page of textual information that is typically made available o a PC. Graphical information also cannot be large. A typical website provides a rich multi-media experience. The same website, when accessed from a cell phone, would be not only unreadable but also frustrating. Thus, there is presenting user with information in order to solicit user input when the user is using a cell phone rather than a PC is a big problem.

Cell phones are therefore a device for which traditional websites are ill prepared to provide information. In addition, surveys or questionnaires that are created for Internet based access via a PC are not appropriate for cell phone access. Asking one or more detailed questions with information on how to answer them is possible on a web page that is accessed from a PC. However, the same web page would be unmanageable and difficult to navigate on a cell phone with a small LCD screen and small keyboard for user input.

Quite often, for marketing purposes, a manufacturer or retailer tries to solicit information and feedback from a customer. Typically, flyers and documents are mailed to customers for them to fill in and send it back. The Internet has facilitated some of these interactions. A user may be requested to visit a website and answers a lot of questions. However, contacting a user is a problem. The manufacturer has to determine some user specific information such as addresses, etc. in order to be able to send them questionnaires or request them to provide feedback. Contacting users via postal services or email for making them answer questionnaires or provide feedback, or answer surveys is therefore time consuming, expensive and labor intensive. Users tend to ignore emails sent to them by considering them to be spam. Postal mails are also often ignored for several reasons, including their association with junk mail.

Often, a question asked of an individual elicits responses that may obviate the need to ask further questions. Unfortunately, traditional questionnaires are not setup to take advantage of users responses. Without detailed instructions provided, questionnaires that try to guide users to specific questions based on their potential answers end up being confusing to a user. Therefore, traditional questionnaires are not flexible or dynamically arranged.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Aspects of the present invention may be seen in a questionnaire network for mobile handsets that facilitates display of questionnaires and collecting responses provided by users. The questionnaire network may comprise a query data population system for creating a questionnaire. The questionnaire comprises a plurality of questions, The query data population system comprises a preamble creator for creating at least one of textual, audio or video preambles and screens to create the plurality of questions. Each of the plurality of questions comprises a question preamble, a question body and an optional supplementary information. The query data population system also comprises a XML based questionnaire publishing component.

Aspects of the invention are also found in a mobile device capable of retrieving and presenting a questionnaire wherein the questionnaire comprises a plurality of questions. The mobile device comprises a questionnaire client system and a display. The questionnaire client system retrieves the questionnaire from a questionnaire server and displays the plurality of questions one question at a time and solicits user input for the plurality of questions.

Aspects of the invention are also found in a questionnaire network for presenting a questionnaire to mobile devices and retrieving responses. The questionnaire network comprises a mobile handset communicatively coupled to a management server, a QStore communicatively coupled to and accessible by the management server, a QPlatform Data Population component communicatively coupled to the Qstore, and an interface to a billing system.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

The numerous objects and advantages of the present invention may be better understood by those skilled in the art by reference to the accompanying figures in which:

FIG. 1 is a perspective block diagram of a questionnaire network for mobile handsets that facilitates creation and dissemination of questionnaires accompanied by user interaction and results gathering activities;

FIG. 2 is an interaction diagram that depicts generic interactions in the questionnaire network between a QPlatform client in a mobile device, a QPlatform server (that includes a QManagement server) and a QPlatform Data population tool that is used to create or assemble questionnaires and surveys;

FIG. 3 is an interaction diagram that depicts an exemplary interactions between the various actors wherein the QPlatform management server communicates a notification to mobile handset device (via an SMS or other means) to initiate a questionnaire, the QPlatform Client software, such as a Java Midlet, is downloaded by the mobile handset, if necessary, before the questionnaire is started and the first question is displayed.

FIG. 4 is an interaction diagram that depicts an exemplary interactions between the various actors wherein the mobile device with a QPlatform client sends a question request to the QPlatform management server, the request being accompanied by appropriate parameters such as the details of questionnaire, last question asked, etc. that the QPlatform management server processes to identify the right next question to send, if one exists.

FIG. 5 is an interaction diagram that depicts an exemplary interactions between the various actors wherein when the user using the mobile handset with a QPlatform client requests supplementary information associated with a current question currently being displayed, the supplementary information is provided as appropriate that is downloaded and played in mobile handset.

FIG. 6 is an interaction diagram that depicts an exemplary interactions between a QPlatform Data population tool and the QPlatform management server in the creation of questions for a questionnaire and in its subsequent storage.

FIG. 7 is an interaction diagram that depicts an exemplary interactions between the QPlaform client in a mobile handset and a QPlatform Server that receives results at the end of the questionnaire (when the user hits the Done button displayed instead of the Next Button) and save them in a results database.

FIG. 8 is an exemplary screen that a user would see on a mobile handset while responding to a question in the questionnaire.

FIG. 9 is an exemplary questionnaire container that is used by the QPlatform data population tool to communicate one or more questionnaires to the QStore, or to the QPlatform management server.

### DETAILED DESCRIPTION OF THE INVENTION

The present invention relates generally to the interactions between a mobile handset and a server within a carrier network, and, more specifically, to the ability to create questionnaires for a mobile handset, store them in a network, and disseminate them to collect results.

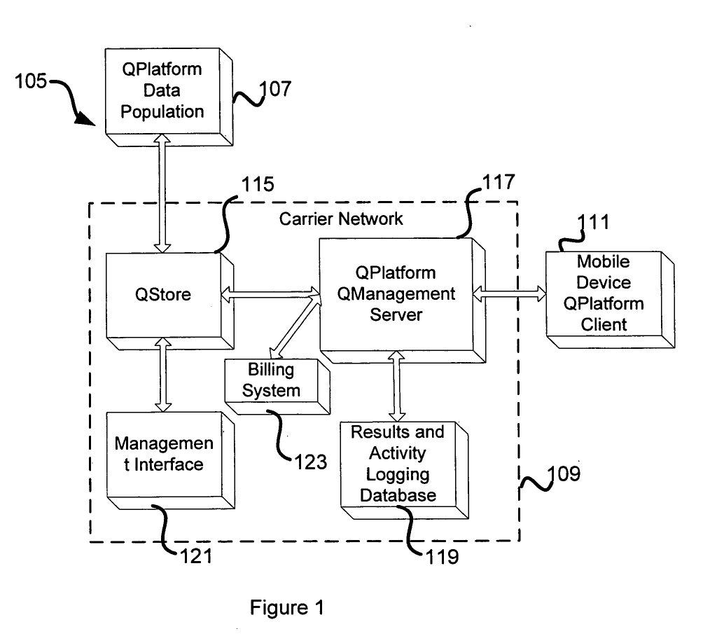

FIG. 1 is a perspective block diagram of a questionnaire network for mobile handsets 105 that facilitates creation and dissemination of questionnaires accompanied by user interaction and results gathering activities. The user interaction is facilitated by a client component in the mobile handsets, such a client component either made available by the manufacturer of the mobile handsets or subsequently downloaded or otherwise installed by the user.

The questionnaire network 105 comprises a mobile handset 111 communicatively coupled to a QPlatform QManagement Server 117 typically located within a carrier network 109, a QStore accessible by the QManagement Server 117 and also by a QPlatform Data Population component 107, a management interface. 121 and a results and activity logging database 119.

The QPlatform Data Population component 107 is used to create questionnaires, surveys, etc. by manufacturers of products, that are then saved in the QStore 115 or in XML files (that are later loaded into QStore). In one embodiment, the QStore 115 is within the carrier network 109 and serves as a repository of questionnaires and surveys, etc. created by one or more product manufacturers (or marketing companies) that are to be disseminated to users of mobile devices (handsets) 111. In another embodiment, the QStore 115 is part of an ASP service (application services platform) managed by an entity external to the carrier network 109, which is communicatively coupled to the carrier network 109.

In one embodiment, the QPlatform data Population component 107 is a web based tool that is used to create questionnaires, with multi-media content or just plain textual content. In another embodiment, it is a stand-alone tool that creates XML based questionnaires and surveys, etc. that are transferred (or published) to the carrier network 109 for loading or storing in the QStore 115 repository.

In one embodiment, the results database 119 is part of the QStore 115. In another embodiment, it is part of the QManagement server 117. In one embodiment, the QManagement server 117 is creates a billing record whenever the mobile device QPlatform Client 111 indicates completion of a questionnaire or survey by a user, the billing record would e used for two purposes, to bill an associated product manufacturer for conducting the questionnaire or survey, and to provide the associated user with a discount on next month's phone bill, a kickback or incentive payment for completing the questionnaire or survey.

In one embodiment, the carrier network's 109 monthly billing system 123, that bills users for landline phone subscriptions or wireless services (as appropriate), is used as a means to provide incentive payments, discounts or rewards to users for completing questionnaires or surveys. For example, the user's monthly phone bill generated by the billing system 123 would discount the monthly payment for the user by $5.00. (or some such amount) for every questionnaire completed by a user of the mobile device 111.

In one embodiment, the questionnaires created by the QPlatform Data Population 107 incorporates a preamble for the questionnaire that could be an audio preamble, a textual preamble, a video preamble, or a combination of the three. In addition, individual questions may have a preamble that is expected to be displayed or rendered just before a question is displayed. In addition, supplementary information that provide additional information about a question, may be incorporated. This may be audio supplementary information that is played by an audio player when the user requests the supplementary information. In one related embodiment, supplementary information is arranged (created or assembled) in multiple levels, and an appropriate supplementary information is displayed or played based upon the level of information the user invokes. In a different embodiment, the mobile device QPlatform client 111 facilitates display/play of the first level of supplementary information while providing the user with the prompts (or buttons) to invoke additional levels of supplementary information, that might provide the user with greater details, if necessary.

The management interface 121 makes it possible to manage questionnaires. For example, the lifecycle of such questionnaires are managed by the management interface 121 (or a management console that uses the interface).

The results and activity logging database provides means to track the users that complete questionnaires and support the associated billing activities. In one embodiment, the mobile device QPlatform client 111 keeps partial results or answers (state information) until the last question has been answered by the user, after which it communicates the complete result set to the QPlatform Qmanagement server 117 for processing or for storage in the results database 119.

In one embodiment, the Qmanagement server 117 receives answers to questions in the questionnaires as soon as each question is answered, and, based on the answers received, the following questions or additional questions are determined or assembled. In a related embodiment, the Qmanagement server 117 maintains static web pages or static content and forwards them to the user on mobile device 111 based upon answers to previous questions and based upon decisions made by a “branching logic” that determines the next questions or additional questions to be asked of the user.

In general, the questionnaire network makes it possible to create, disseminate, conduct questionnaires or surveys on mobile handsets and to collect results for processing and storage. In one embodiment, supplementary information, in audio form, is provided to the user to provide more details about a question when the user requests it. In addition, audio preambles for the questionnaire and for individual questions are possible that make it easy to setup the context for the questionnaire or an individual question without requiring the user to read a lot of textual information in a constrained device.

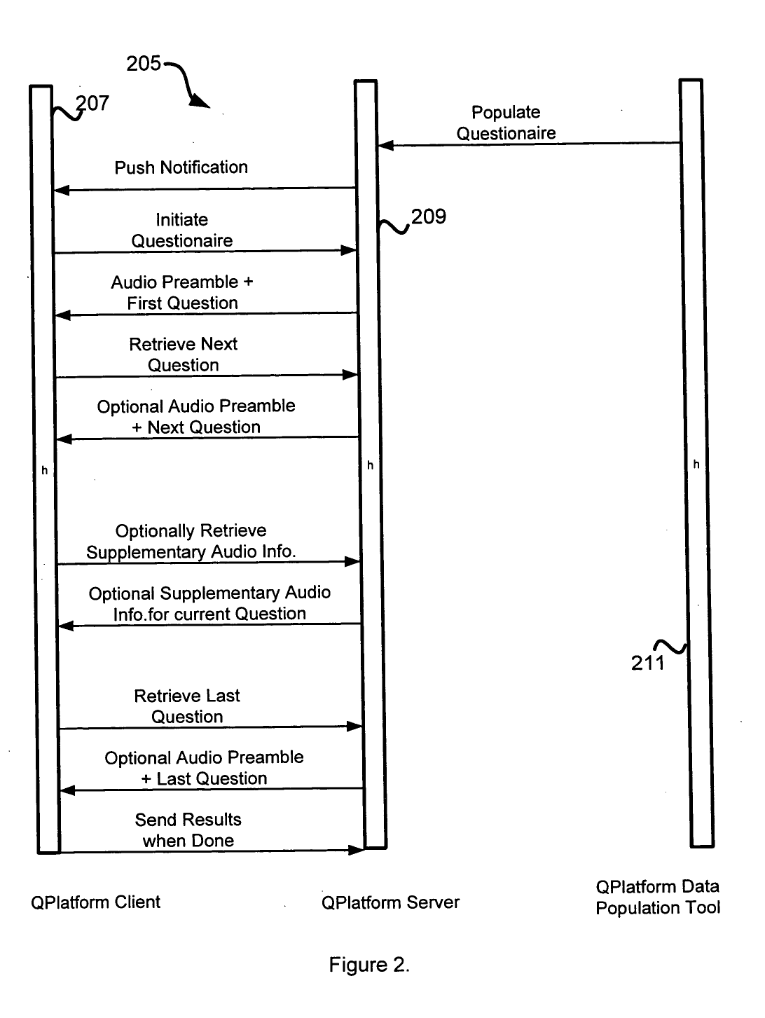

FIG. 2 is an interaction diagram that depicts generic interactions in the questionnaire network between a QPlatform client 207 in a mobile device, a QPlatform server 209. (that includes a QManagement server) and a QPlatform Data population tool 211 that is used to create or assemble questionnaires and surveys. Typically, questionnaires deposited into the QStore repository of the QPlatform server 209 are made available for user access (by configuring it or managing it via a management console). A push notification is sent to a user in one embodiment, such as by means of an SMS message. User-initiated questionnaire startup is also possible. When a questionnaire is initiated, an audio preamble may be played, if necessary, on the client device (using an audio player, such as an MP3 player, etc.). Typically, when a questioned is displayed, two buttons (or menu items) are also displayed, one an ‘Info’ button (or menu item) and another a ‘Next’ button or menu item. When the last question is displayed, the. ‘Next’ button or menu item is replaced by a ‘Done’ button or menu item ‘Done’ would indicate that the questionnaire was completed and the results gathered by the client is to be communicated to the carrier network, such as to the QManagement server or a billing server, etc.

The required functionality of the QPlatform client and server components are described for the present invention. It's interface to external systems, such as a billing system, is also described in the present invention.

In one embodiment, the various components required for deploying a solution comprises a QPlatform Client, a QPlatform Server, a QPlatform Management Interface and a QPlatform Data Population component. In a related embodiment, the QPlatform Server supports standard http based data transfer of questionnaires and other related information to QPlatform clients. The QPlatform Client employ http based data transfers for communicating with the QPlatform servers. Only static pages or content can be transferred to the client by the server in another related embodiment and J2ME platforms on mobile devices are also employed in some others. The data population tool is necessary to ease adoption of the QPlatform solution.

The QPlatform Server shall either push questions from a questionaire to mobile devices in server-initiated mode or transfer questions from a questionaire to mobile devices following a request from the client. For example, the QPlatform Server may receive requests for questions of a questionaire from one or more mobile devices and provide mechanisms to support such data transfers. In general, it facilitates the identification of appropriate questionaires, the establishment and maintenance of communication links with handsets for data transfer purposes and the subsequent communication of appropriate questions to one or more handsets.

The QPlatform Server interacts with a QStore to retrieve questionnaire related information. It retrieves information on questions to be transferred to the client devices, and, once a questionnaire is started, primarily static web pages, possibly cached, are delivered to the client.

In one embodiment, the scalability, availability and reliability requirements are expected to be met as static web pages are primarily transferred to the client devices. The QPlatform Server does not store state information, in a related embodiment. Thus, even if branching logic is executed on the server-side, static pages are expected to be delivered to client devices. Thus, the design of the QPlatform Server permits high scalability, availability and reliability.

Various questionaire results are collected and are logged by the QPlatform server employing result databases and an activity logging database or in an external database accessed over an API.

The potential market segments that for the use of the Qplatform server and client products described in the present invention are the telecom operators, manufacturers of various consumer products, such as Coke, Lexus, etc., and marketing companies such as Ogilvy. & Mather.

In one embodiment, product manufacturers use the present invention to gather information from customers via questionnaires.

Carriers are the secondary market as they can provide targeted marketing opportunities and billing support while also providing for user incentive management by providing users with the right amount of incentives to ensure their participation.

Typically, Questionaires or Surveys under 10 questions (not counting qualifying questions) usually have a drawing for one cash prize. Surveys over 10 questions, usually offer individual incentive to those who complete the entire questionnaire. Payment is by check from the manufacturer of the product or from a company conducting the survey, drawn on a (US) bank, usually in amounts from $2 to $10.

In one embodiment, the present invention involves recruiting the telecom carrier/telecom operator to use their billing system to provide “payment” to the participant by means of “discounts” or “deductions” on the next month's phone bill.

In general, the QPlatform Client on mobile devices access the QPlatform Server to retrieve Questions and related information, one at a time, until the end of the questioner when the client devices report their results to the QPlatform Server for processing. Individual questionnaires are created by product manufacturers or firms conducting surveys using the QPlatform Data Population tool. This tool can deliver the questionnaires created to the QStore database, if necessary.

In one embodiment, the QStore is an externally hosted solution, outside the operator network, which provides access to the QPlatform Management System when it needs to retrieve questionnaires or individual questions.

In one embodiment, the QPlatform Server comprises the following subcomponents and interfaces:
QStore database
QPlatform QManagement Server
Results and Activity Logging Database
Management Interface

The primary goal of the QPlatform Server is to support downloads of a sequence of questions from a questionnaire to client devices accompanied optionally by user-initiated delivery of supplementary information (details of a particular question) in audio (or even in video) format.

In one embodiment, the QPlatform Server facilitates questionnaire downloads to individual mobile devices over the default protocol such as http. It employs the QStore Interface to retrieve an appropriate questionaire. It processes user requests and transfers questions until the last one in a questionaire is encountered, at which point it receives the results from the client device. It populates the results into a results database. It employs an activity logging database to log activity related information, questionaire related information, customer-related information (if necessary), etc.

In one embodiment, the QPlatform Client Component is a java midlet that executes in a J2ME environment on the mobile device. It supports display of user questions received from the QPlatform Server as part of a questionnaire. This component also facilitates initiation of “informative” audio downloads to mobile devices that supplemental textual prompts to the user and provide more information that might be necessary. It also facilitates display of notification sent by the QPlatform server before a questionnaire is initiated. This implies that an unsolicited “push-mode” questionnaire initiation is supported.

In one embodiment, the QPlatform Data Population Component is a simple and “easy-to-use” tool, that is web-based, that provides screens to create questionnaires and save the results in the QStore or as an XML file (or both). It provides a means to capture audio input for “informative” supplementary information for each question and for the overall questionnaire. Means to associate other audio data previously recorded is also provided.

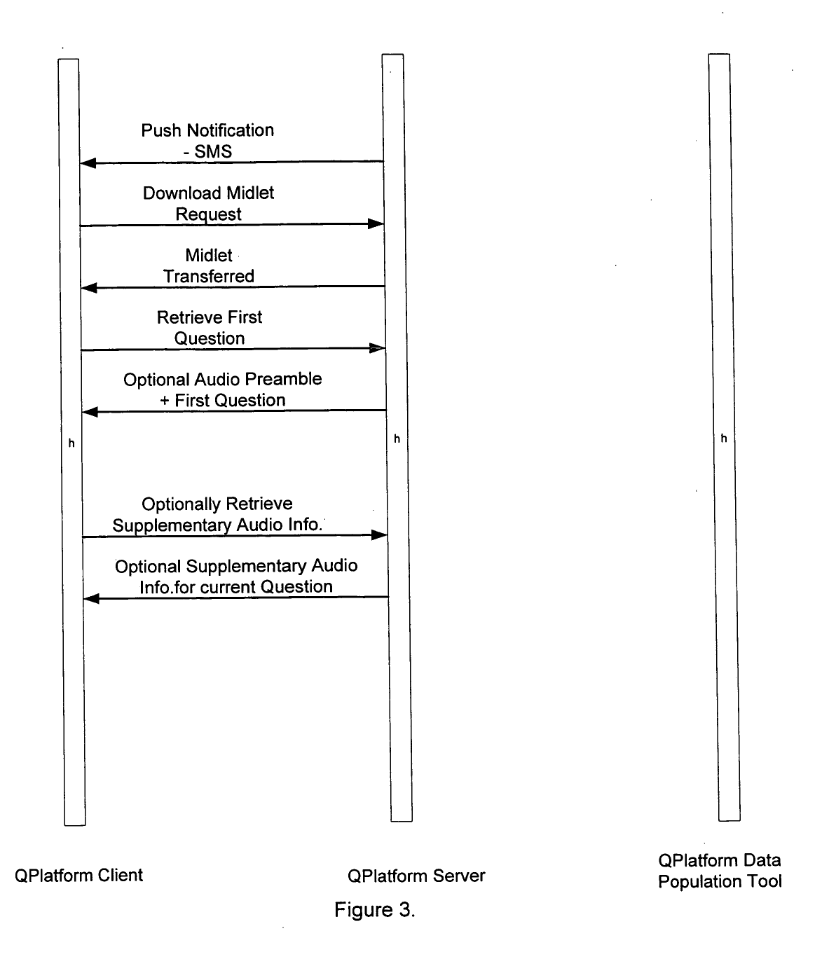

FIG. 3 is an interaction diagram that depicts an exemplary interactions between the various actors wherein the QPlatform management server communicates a notification to mobile handset device (via an SMS or other means) to initiate a questionnaire, the QPlatform Client software, such as a Java Midlet, is downloaded by the mobile handset, if necessary, before the questionnaire is started and the first question is displayed. The downloaded Java Midlet or other QPlatform client is able to execute instructions to display questionnaires, play audio preambles and audio supplementary information, if necessary, etc.

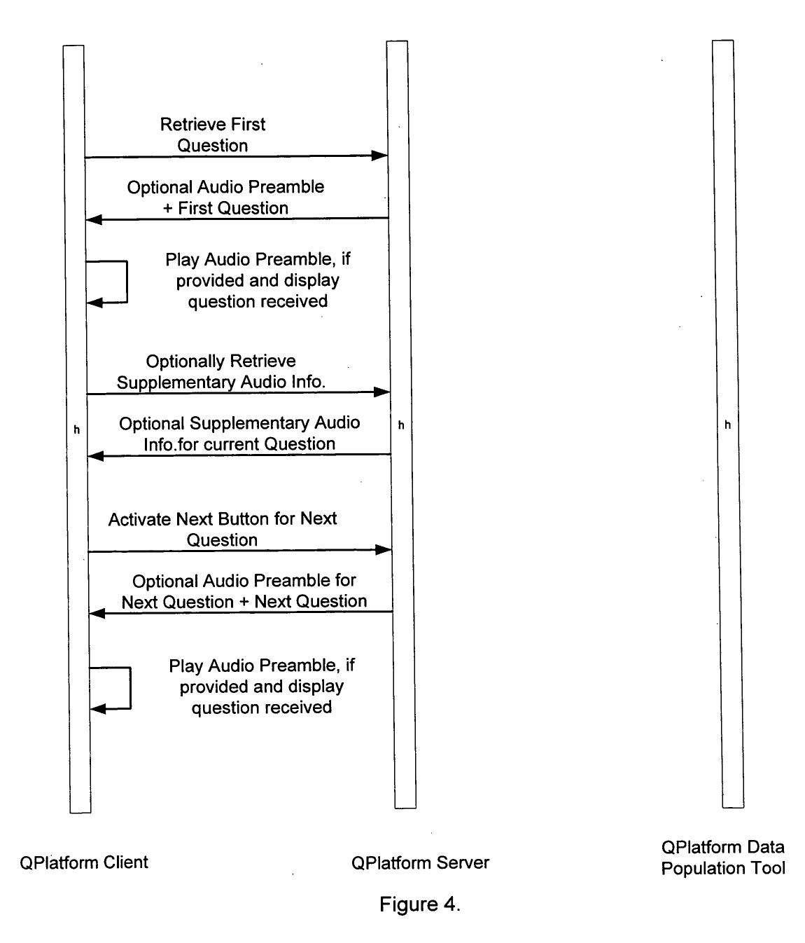

FIG. 4 is an interaction diagram that depicts an exemplary interactions between the various actors wherein the mobile device with a QPlatform client sends a question request to the QPlatform management server, the request being accompanied by appropriate parameters such as the details of questionnaire, last question asked, etc. that the QPlatform management server processes to identify the right next question to send, if one exists. In one embodiment, the question request from a QPlatform client is accompanied by the response for the current question, and the QPlatform management server dynamically determines the next question based on the response for the current question, and, optionally, the responses received for all previous questions for the questionnaire that has been asked.

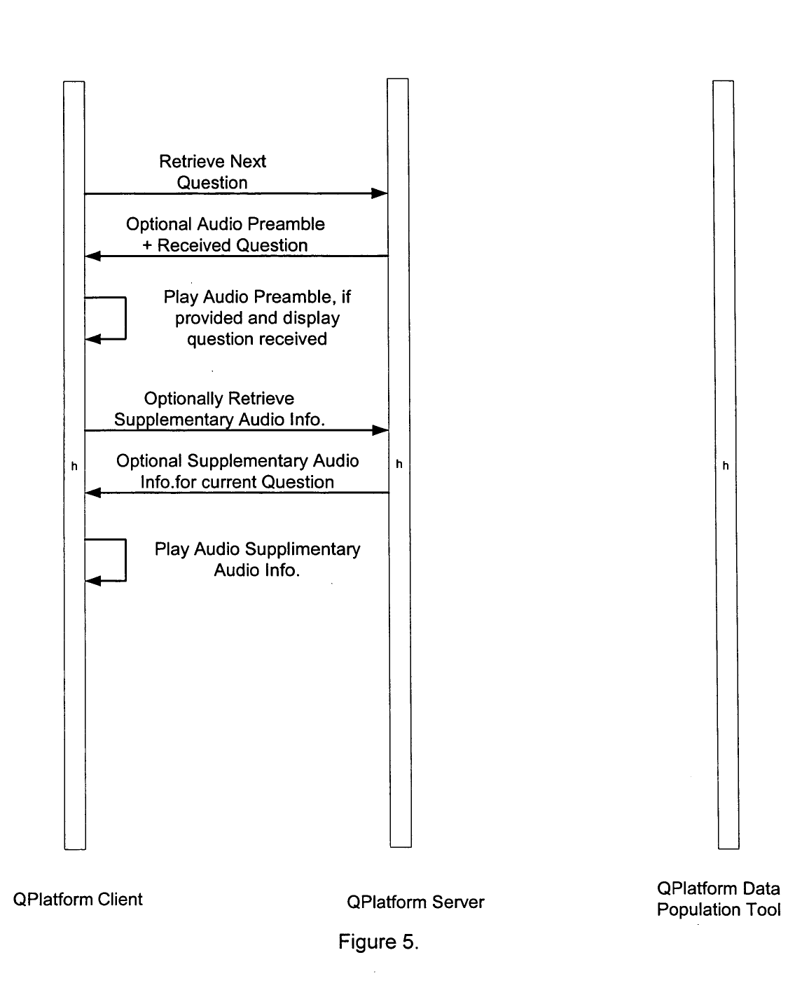

FIG. 5 is an interaction diagram that depicts an exemplary interactions between the various actors wherein when the user using the mobile handset with a QPlatform client requests supplementary information associated with a current question currently being displayed, the supplementary information is provided as appropriate that is downloaded and played in mobile handset. In the mobile handset, an appropriate audio player, that is present in the device, or automatically downloaded (obtained at runtime), is employed.

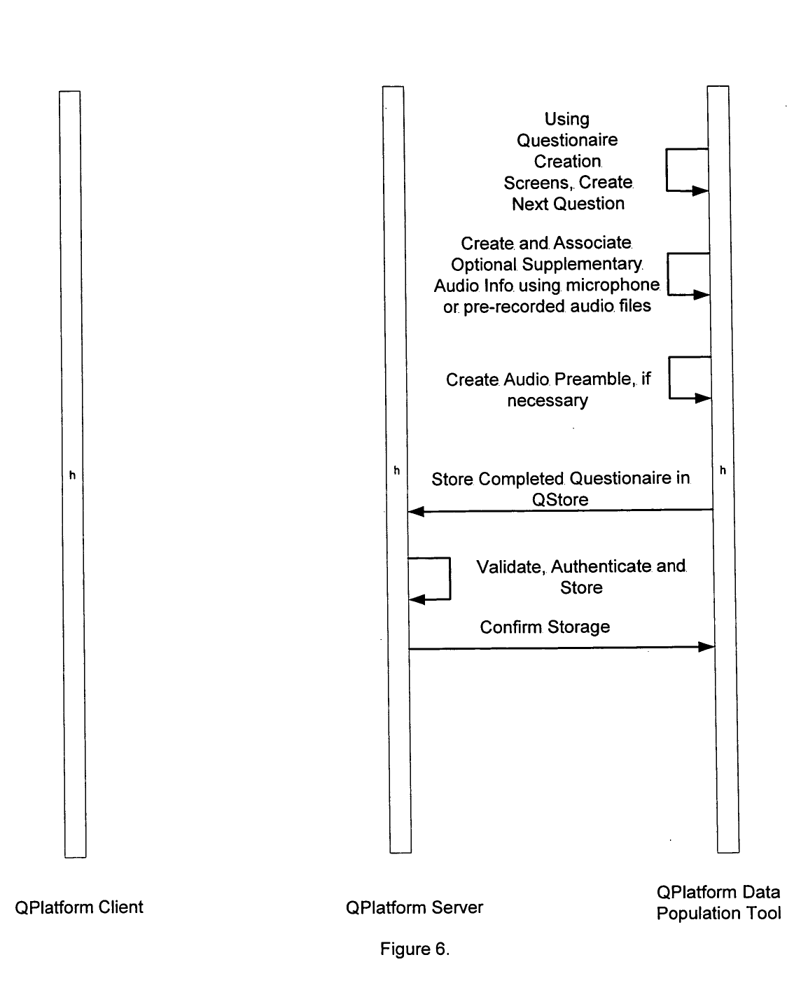

FIG. 6 is an interaction diagram that depicts an exemplary interactions between a QPlatform Data population tool and the QPlatform management server in the creation of questions for a questionnaire and in its subsequent storage. In general, audio and text input for each question is created in the QPlatform Data population tool and the whole questionnaire is saved in QStore. In one embodiment, partial questionnaires can be stored in the QStore and subsequently retrieved to complete it.

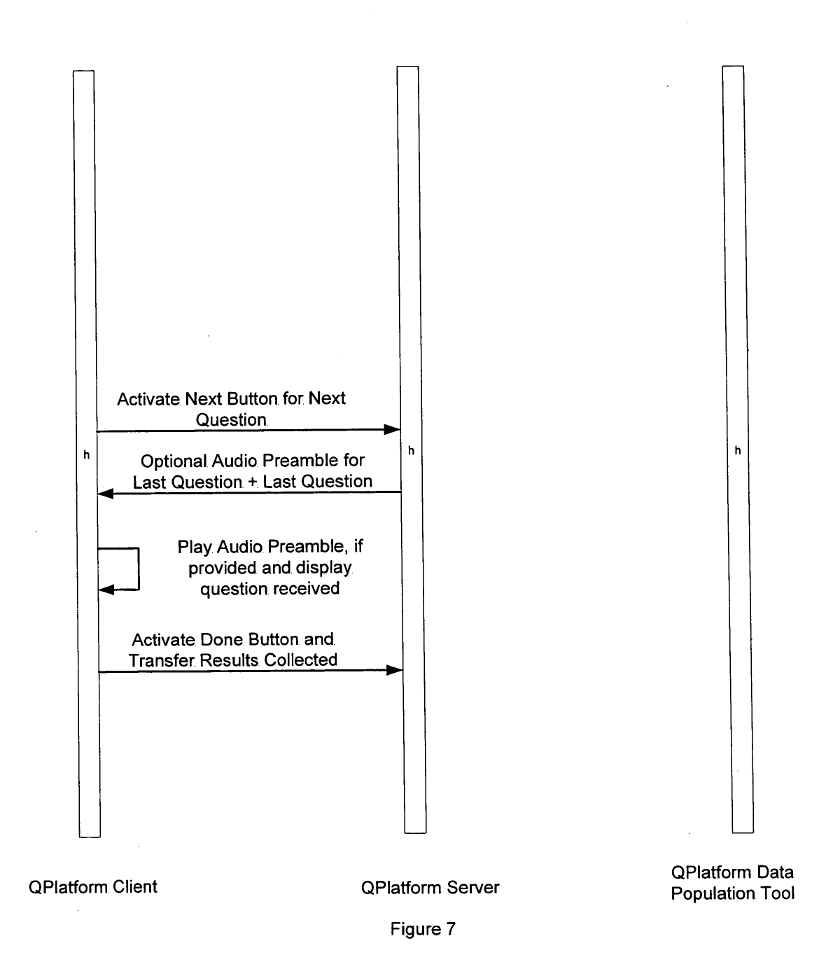

FIG. 7 is an interaction diagram that depicts an exemplary interactions between the QPlaform client in a mobile handset and a QPlatform Server that receives results at the end of the questionnaire (when the user hits the Done button displayed instead of the Next Button) and save them in a results database.

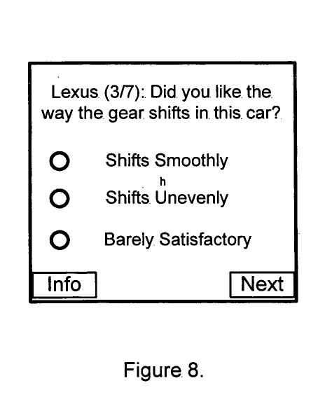

FIG. 8 is an exemplary screen that a user would see on a mobile handset while responding to a question in the questionnaire. It presents an exemplary user screen displayed by the QPlatform Client to solicit user input for a question that is part of a questionnaire. The question number is displayed —3rd out of 7 in the example. An Info and Next buttons are also displayed. The Next button, when activated, retrieves and displays the next question in the questionnaire. For the last question, the Next button is replaced by a Done button.

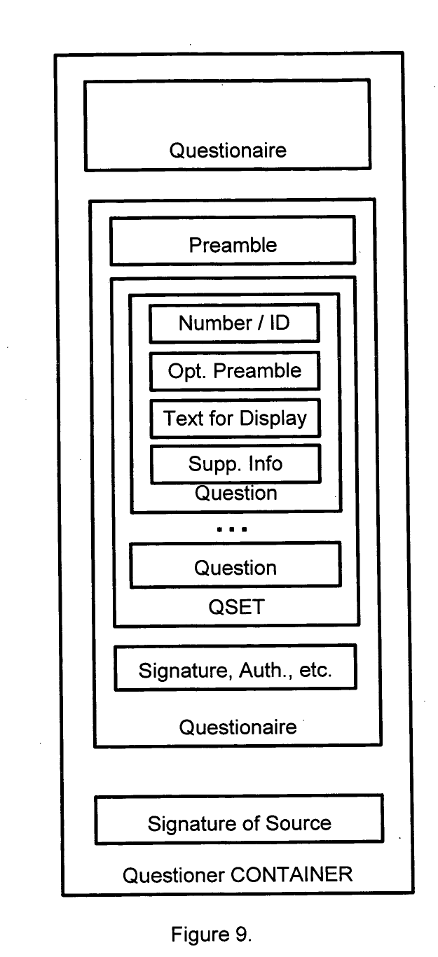

FIG. 9 is an exemplary questionnaire container that is used by the QPlatform data population tool to communicate one or more questionnaires to the QStore, or to the QPlatform management server. It depicts an exemplary structure of the questionnaire container and a questionnaire.

The following are some of the features provided by the QPlatform questionnaire network:
1) Notification is sent to client device/user (via SMS) to initiate a questionnaire, the mobile client device downloads a client software, such as a midlet if necessary. Then the questionnaire is started in the mobile handset and the first question is displayed for a user response. Alternatively, the user sends an inquiry to the Qplatform server environment (specifically, the Qplatform management server) to determine the availability of a questionnaire.

2). A user starts questionnaire, selects choice(s) for a response for the first question, hits the next button and receives the next question from the questionnaire.

3). The Qplatform client in the mobile handset is capable of retrieving a question and facilitating its display, including rendering of video components, playing if audio components, display of text, etc.

4). When a mobile device with Qplatform client sends a request for a question to the Qplatform server environment, it sends appropriate parameters, such as the details of questionnaire, last question asked, etc. The Qplatform management server processes it, identifies the right question to send, if one exists, and transfers it.

5). A user requests supplementary audio information by activating the “info” button or a menu item. Appropriate audio is downloaded and played in mobile device when the user seeks supplementary information, which is provided as audio input. If supplementary information needs to be provided as text, then such text, either accompanied by available supplementary audio information or otherwise, is displayed when the user selects the “info” button. For the playing of audio supplementary information, the right player must be in device, or obtained at runtime.

6) The Qplatform data population component provides screens to create a questionnaire and save them.

7) Audio and text input for each question is created and the whole questionnaire is saved in QStore.

8). Results of the questionnaire are obtained by the Qplatform management server and saved.

10). The QPlatform Server receives results at the end of the questionnaire. (when typically the user hits the Done button displayed, instead of the Next Button) and save s them in a results database. Simultaneously, a record is logged, and optionally a Billing record is created, using a billing interface or a billing system available.

11). The QPlatform management Server does not provide User Interface screens or forms to end users. Instead, mobile device users employ appropriate screens on client-side using the Qplatform client component (such as a J2ME tool) to access questionnaires, downloadable text and audio, and render them.

12). The QPlatform Data Population provides an easy to use user interface that is used to populate questionnaire data in a database or in an XML file that is subsequently stored. QPlatform Management Interface, if employed, provides screens to manage the life cycle of questionnaires. The only screens that the QPlatform management Server may need to provide are those required to start and stop the QPlatform management Server instances at run-time and those required to load questionnaires for initialization.

In one embodiment, the QPlatform Server supports standard http based interactions with QPlatform Clients in mobile handsets. The QPlatform Client employs http based data transfer. In a related embodiment, only static questionnaire pages or content are transferred to the QPlatform client by the QPlatform server. In another related embodiment, the Qplatform client is a J2ME application that is executed on a mobile handset. The Qplatform data population tool is used to create questionnaires and store them in the QPlatform QStore.

In one embodiment, the process of creating questionnaires and soliciting user input comprises the following steps:
1. Creating a questionnaires
2. Storing a questionnaire
3. Initiating questionnaire from mobile handset that has the QPlatform client
4. Providing audio preamble to the questionnaire.
5. Providing an “audio” preamble if necessary for some questions.
6. Providing supplementary information in the form of informative audio input, when available and when necessary.
7. Completing questionnaire
8. Collecting Results Data
9. Billing and logging

Billing may be facilitated by a billing system that sends monthly bills to a customer, such as a monthly phone bill that provides discounts for questionnaires completed by a subscriber.

The QPlatform management server may either push questions from a questionnaire to mobile devices in server-initiated mode or transfer questions from a questionnaire to mobile devices following a request from the client. For example, the QPlatform Server may receive requests for questions of a questionnaire from one or more mobile devices and provide mechanisms to support such data transfers. In general, it facilitates the identification of appropriate questionnaires, the establishment and maintenance of communication links with handsets for data transfer purposes and the subsequent communication of appropriate questions to one or more handsets.

The QPlatform management server interacts with a QStore to retrieve questionnaire related information. It retrieves information on questions to be transferred to the client devices, and, once a questionnaire is started, primarily static web pages, possibly cached, are delivered to the client.

Various Questionnaire results are collected and are logged by the QPlatform management server employing a result database and an activity logging database, or in an external database accessed over an API.

In general, the QPlatform Client on mobile devices access the QPlatform management Server to retrieve Questions and related information, one at a time, until the end of the questionnaire when the client devices report their results to the QPlatform management Server for processing. Individual questionnaires are created by product manufacturers or firms conducting surveys using the QPlatform Data Population tool, that can deliver the questionnaires created in the QStore database, if necessary.

NOTE: the QStore may be an externally hosted solution, outside the carrier network, which provides access to the QPlatform Management server when it needs to retrieve questionnaires or individual questions.

In one embodiment the questionnaire network comprises a QPlatform Data Population Tool that facilitates creation and storage of questionnaires, a QPlatform Server that disseminates questionnaires and collects results and a QPlatform Client that provides screens for user interaction and displays questions from questionnaires and plays audio input provided.

In one embodiment, the Qplatform server ends notification to client device/user (via SMS) to initiate questionnaire, Client device downloads, midlet if necessary, questionnaire is started and the first question is displayed.

The Structure of an examplary self-contained Questionnaire Container and a Questionnaire is provided below. Note that the example provides for the incorporation of metadata and data at the same level of the XML structure for the Questionnaire element.

| <Q> | |
|---|---|
| <QUESTIONAIRE> | |
| <NAME> | </NAME> |
| <DESCRIPTION> | </DESCRIPTION> |
| <CREATIONDATE> | </CREATIONDATE> |
| <SIZE> | </SIZE> |
| <AVGTIME> | </AVGTIME> |
| <PREAMBLE> | </PREAMBLE> |

| <VENDOR> | |
|---|---|
| <VENDORNAME> | </VENDORNAME> |
| <VENDORDETAILS> | </VENDORDETAILS> |

| <PARAMETERS> | |
|---|---|
| <PARAMETER> | |
| <PARAMETERNAME> | |
| </PARAMETERNAME> | |
| <PARAMETERVALUE> </PARAMETERVALUE> | |
| </PARAMETER> | |
| <PARAMETERS> | |
| </VENDOR> | |
| <PARAMETERS> | |
| <PARAMETER> | |
| <PARAMETERNAME> </PARAMETERNAME> | |
| <PARAMETERVALUE> </PARAMETERVALUE> | |
| </PARAMETER> | |
| <PARAMETERS> | |
| <QUESTION> | |
| <NUMBER> | </NUMBER> |
| <ID> | </ID> |

| | |
|---|---|
| <QPREAMBLE> | </QPREAMBLE> |
| <TEXT> | </TEXT> |

| <SUPPLEMENTARY> </SUPPLEMENTARY> | |
|---|---|
| <MULTIPLECHOICETYPE> | |
| </MULTIPLECHOICETYPE> | |
| <MULTIPLECHOICE> | |
| <CHOICE>... </CHOICE> | |
| <CHOICE>... </CHOICE> | |
| <CHOICE>... </CHOICE> | |
| <CHOICE>... </CHOICE> | |
| </MULTIPLECHOICE> | |
| </QUESTION> | |
| <QUESTION> ... </QUESTION> | |
| <QUESTION> ... </QUESTION> | |
| </QUESTIONAIRE> | |
| <QTYPE> </QTYPE> | |
| <SIGNATURETYPE> | </SIGNATURETYPE> |
| <SIGNATURE> | </SIGNATURE> |
| <Q> | |

NOTE: It is also possible to have a questionnaire where some text or audio components of the questions come from external sources whose URL's or other references and provided in the questionnaire.

NOTE: Within a container, several questionnaires may be enclosed. For example, in one container, each questionnaire may be targeted towards a different language or marketing region and one of the parameters in a questionnaire specifies the actual marketing region or language that it supports.

NOTE: W3C. based XML Signatures are also contemplated instead of the ones shown above.

The supplementary information may be textual, audio inputs, video inputs, or a combination of the three. When the info button or menu item is activated, the supplementary information is displayed or rendered. For example, an audio player may be used to play supplementary audio inputs. Similarly, a video player may be used to render/display video information.

In one embodiment, multiple-tiers of supplementary information is supported. Thus, when the. ‘Info’ button on the keypad, the ‘Info’ menu item, or other ‘Info’ activating widgets is activated, the first level supplementary information will be displayed, rendered or played, as appropriate, with an additional level of ‘Info’ prompt made provided for further assistance. It should be possible to back up to the current question display after one or more levels of supplementary information are accessed/viewed or otherwise consumed.

In one embodiment, payment to a customer for successfully completing a questionnaire is provided through an operator's billing system. One innovative feature is the payment for participation in mobile surveys or questionnaires being arranged via a “deduction” or “discount” to the participants monthly phone bill. The telecom carrier's billing system can be employed to support this. An interface to the carrier's billing system can be provided from the QPlatform Server to enable such transactions with the billing system.

The following is an exemplary DTD that can be used by a manufacturer to create questionnaires and save them in a standard format in order to communicate them to a carrier network or web server (or a repository).

```
  <?xml version=“1.0” encoding=“UTF-8”?>
  <!ELEMENT Q (QUESTIONAIRE+, SIGNATURE) >
  <!ELEMENT  QUESTIONAIRE  (NAME,  DESCRIPTION,
CREATIONDATE,
    SIZE, AVGTIME, QPREAMBLE, VENDOR, PARAMETERS,
    EFFECTIVEDATE, QSET, SIGNATURE) >
  <!ELEMENT QSET ( QUESTION+ ) >
  <!ELEMENT QUESTION (NUMBER, ID, QPREAMBLE, TEXT,
    SUPPLEMENTARY, MULTIPLECHOICETYPE,
    MULTIPLECHOICE) >
  <!ELEMENT MULTIPLECHOICE (CHOICE+) >
  <!ELEMENT CHOICE (CHOICEID, ITEM)>
  <!ELEMENT CHOICEID (#PCDATA)>
  <!ELEMENT ITEM (STRINGCONTENT|IMAGE)>
  <!ELEMENT IMAGE (#PCDATA)>
  <!ELEMENT STRINGCONTENT (#CDATA)>
  <!ELEMENT SUPPLEMENTARY (LEVEL, STYPE, SCONTENT)+>
  <!ELEMENT LEVEL (#PCDATA)>
  <!ELEMENT STYPE (#PCDATA)>
  <!ELEMENT SCONTENT (#PCDATA)>
  <!ELEMENT QPREAMBLE (PMODE, PCONTENT)>
  <!ELEMENT PMODE (#PCDATA)>
  <!ELEMENT PCONTENT (STRINGCONTENT|AUDIOCONTENT )>
  <!ELEMENT AUDIOCONTENT (#PCDATA)>
  <!ELEMENT NAME (#PCDATA) >
  <!ELEMENT DESCRIPTION (#CDATA) >
  <!ELEMENT VENDOR (VENDORNAME, VENDORDETAILS,
  PARAMETERS* ) >
  <!ELEMENT VENDORNAME (#CDATA) >
  <!ELEMENT VENDORDETAILS (#CDATA) >
  <!ELEMENT PARAMETERS (PARAMETER*) >
  <!ELEMENT PARAMETER (PARAMETERNAME,
PARAMETERVALUE) >
  <!ELEMENT PARAMETERNAME (#CDATA) >
  <!ELEMENT PARAMETERVALUE (#PCDATA) >
  <!ELEMENT CREATIONDATE (#PCDATA) >
  <!ELEMENT SIZE (#PCDATA)>
  <!ELEMENT AVGTIME (#PCDATA)>
```

Other DTDs with slight variations are also contemplated, such as those that support for simultaneous display of audio and video supplementary information, support for W3C. based digital signatures, etc.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A query data population system for creating a questionnaire wherein the questionnaire comprises a plurality of questions, the query data population system comprising:
a preamble creator for creating at least one of textual, audio or video preambles;
screens to create the plurality of questions;
each of the plurality of questions comprising a question preamble, a question body and an optional supplementary information; and
an XML based questionnaire publishing component.

2. The query data population system of claim 1 wherein the preamble creator creates a preamble that comprises at least one of an audio preamble, a textual preamble and video preamble and the questionnaire further comprises an optional questionnaire preamble.

3. The query data population system of claim 2 wherein the question body comprises at least one of a multiple choice question, a data input field and a group of selectable radio buttons, or a combination of the three.

4. The query data population system of claim 3 wherein the supplementary information comprises at least one of an audio supplementary information, a textual supplementary information and a video supplementary information.

5. The query data population system of claim 4 wherein the question preamble is displayed, played or rendered, as appropriate, just before a question is displayed.

6. The query data population system of claim 5 wherein the audio supplementary information is played by an audio player when the user requests the supplementary information.

7. The query data population system of claim 5 wherein the audio supplementary information is arranged in a plurality of levels such that an appropriate supplementary information of an appropriate one of the plurality of levels can be displayed or played based upon the level of information invoked.

8. A mobile device capable of retrieving and presenting a questionnaire wherein the questionnaire comprises a plurality of questions, the mobile device comprising:
a questionnaire client system;
a display;
the questionnaire client system retrieving the questionnaire from a questionnaire server and displaying the plurality of questions, one question at a time, and soliciting user input for the plurality of questions.

9. The questionnaire client system according to claim 8 wherein each of the plurality of questions comprises a question preamble, a question body and an optional question supplementary information and the questionnaire client system displays the question preamble, then displays the question body and optionally, if necessary, display the question supplementary information for each question, in an attempt to solicit user input.

10. The questionnaire client system according to claim 9 wherein the question preamble is an audio preamble and the questionnaire client system plays the audio preamble employing an audio player before displaying the question body.

11. The questionnaire client system according to claim 9 wherein the question preamble is an audio preamble and the questionnaire client system plays the audio preamble employing an audio player while displaying the question body.

12. The questionnaire client system according to claim 9 wherein the question supplementary information preamble is an audio information and the questionnaire client system plays the audio information employing an audio player when the question supplementary information is solicited.

13. The questionnaire client system according to claim 9 wherein the question supplementary information preamble is an audio information and the questionnaire client system plays the audio information employing an audio player when the question supplementary information is solicited while simultaneously displaying the question body.

14. The questionnaire client system according to claim 9 wherein the questionnaire further comprises a questionnaire preamble that the questionnaire client system displays prior to the display of the first of the plurality of questions.

15. The questionnaire client system according to claim 14 wherein the questionnaire preamble comprises an audio information that the questionnaire client system plays employing an audio player and wherein the audio information can be repeatedly played employing the audio player.

16. The questionnaire client system according to claim 14 wherein the questionnaire preamble comprises a video information that the questionnaire client system displays employing a video display component.

17. The questionnaire client system according to claim 9 further comprising:
an audio player that is used to play an optional audio questionnaire preamble and an optional audio question preamble;
screens to display the plurality of questions one at a time;
a communication unit to retrieve the questionnaire from an external system and submit an user input for the questionnaire to the external system; and
a results display screens to optionally display results of the questionnaire.

18. The questionnaire client system according to claim 17 wherein multiple levels of supplementary preamble and questionnaire preamble are supported and wherein the first of the multiple levels is displayed or played before additional levels are displayed or played based on a subsequent user selection.

19. The questionnaire client system according to claim 17 wherein at least one of the questionnaire preamble, the question preamble and the supplementary information are presented as an audio information.

20. The questionnaire client system according to claim 17 wherein the question body is presented as a visual display while the response to the question body is received as an audio input.

21. A questionnaire network for presenting a questionnaire to mobile devices and retrieving responses, the questionnaire network comprising:
a mobile handset communicatively coupled to a management server;
a QStore communicatively coupled to and accessible by the management server;
a QPlatform Data Population component communicatively coupled to the Qstore; and
an interface to a billing system.

22. The questionnaire network of claim 21 wherein the questionnaire is presented to a user of the mobile handset and the user's responses are collected as an audio response information that is communicated to the management server by the mobile handset.

23. The questionnaire network of claim 21 wherein the questionnaire comprises a plurality of questions and the management server presents each of the plurality of questions one question at a time and receives a corresponding response for each of the plurality of questions before a next one of the plurality of questions is communicated to the mobile handset for display to a user.
is presented to a user of the mobile handset and the user's responses are collected as an audio response information that is communicated to the management server by the mobile handset.

24. The questionnaire network of claim 23 wherein the management server receives a response to each of the plurality of questions in the questionnaire as soon as the each of the plurality of questions is answered by the user, and, based on the received response, the next one of the plurality of questions is determined or assembled and presented to the mobile handset.

25. The questionnaire network of claim 24 further comprising:
the mobile handset comprising a next button, that, when activated, causes the storage of the response for the one of the plurality of questions currently being displayed and retrieves another of the plurality of questions for display;
an info button that retrieves a supplementary information associated with the one of the plurality of questions currently being displayed.

26. The questionnaire network of claim 25 wherein the mobile handset replaces the next button with a done button when the last question among the plurality of questions is displayed, that, when activated, would indicate to the management server that the questionnaire was completed and also cause the results gathered by the mobile handset to be communicated to at least one of the management server and the billing interface.

27. The questionnaire network of claim 25 wherein the questionnaire is deposited into the QStore by the QPlatform Data Population component so as to make the questionnaire available for user access, in response to which the management server communicates a push notification to the mobile handset to indicate the availability of the questionnaire.
